(19) United States
(12) Patent Application Publication
(10) Pub. No.: US 2025/0136401 A1
(43) Pub. Date: May 1, 2025

(54) BUSINESS SHEET PROCESSING SYSTEM, BUSINESS SHEET PROCESSING METHOD, AND RECORDING MEDIUM

(71) Applicant: NEC Corporation, Minato-ku, Tokyo (JP)

(72) Inventors: Akihiko ONITA, Tokyo (JP); Ryo NAKAGAWA, Tokyo (JP)

(73) Assignee: NEC Corporation, Minato-ku, Tokyo (JP)

(21) Appl. No.: 18/834,359

(22) PCT Filed: Mar. 1, 2022
(86) PCT No.: PCT/JP2022/008502

§ 371 Date: Jul. 30, 2024

(51) Int. Cl. B65H 29/26; B07C 5/02; B07C 5/36; B25J 9/16; G06T 1/00; G06V 20/52

(52) U.S. Cl. CPC B65H 29/26; B07C 5/02; B07C 5/361; B25J 9/1697; G06T 1/0014; G06V 20/52; B07C 2501/0063; B65H 2301/161; B65H 2301/424; B65H 2408/112; B65H 2511/40; B65H 2553/42; G06V 2201/06

(57) ABSTRACT

A business sheet processing system according to an aspect of the present disclosure includes at least one memory configured to store instructions; and at least one processor configured to execute the instructions to: recognize a business sheet placed in a first area of a basket; control, based on the recognition result, extraction of the business sheet from the first area of the basket by a robot; determine whether the business sheet is sortable; control the robot to proceed a business sheet extracted by the robot and determined to be sortable to a sorting process; and control the robot to move a business sheet extracted by the robot and determined to be unsortable to a second area of the basket.

### TECHNICAL FIELD

The present disclosure relates to a business sheet processing system and the like.

### BACKGROUND ART

In a store such as a convenience store, business sheets including proxy storage paper, a slip, a gift certificate, and a receipt are handled. These business sheets are collected from each store to an accounting center and classified by type. The contents of the classified business sheets are registered in the system.

PTL 1 discloses a method of identifying a document and a binding tool and removing the binding tool using a robot arm. In PTL 1, information in terms of document is digitally extracted and stored.

### CITATION LIST

### Patent Literature

PTL 1: JP 2019-505893

### SUMMARY OF INVENTION

### Technical Problem

If a business sheet is bent or rounded, or a plurality of business sheets are held by using a stapler, it is difficult to sort the business sheets and register the contents of the business sheets by using the system. Therefore, when a business sheet that is difficult to process is detected during process by the system, wrinkles of the business sheet are stretched or staples are removed in such a way that the system can easily process the business sheet. However, if the system is stopped every time a business sheet that is difficult to process is detected, the processing speed of the system decreases.

An object of the present disclosure is to provide a business sheet processing system and the like that can suppress a decrease in processing speed even when there is a business sheet that is difficult to process.

### Solution to Problem

A business sheet processing system according to the present disclosure includes: a recognition means for recognizing a business sheet placed in a first area of a basket; a control means for controlling, based on the recognition result, extraction of the business sheet from the first area of the basket by a robot; and a determination means for determining whether the business sheet can be sorted, wherein the control means controls the robot based on the determination result in such a way as to cause, among the business sheets extracted by the robot, business sheets that can be sorted to proceed to a sorting process, and business sheets that cannot be sorted to move to a second area of the basket.

A business sheet processing method according to the present disclosure including recognizing a business sheet placed in a first area of a basket; controlling, based on the recognition result, extraction of the business sheet from the first area of the basket by a robot; and determining whether the business sheet is sortable, wherein the robot is controlled based on the determination result to proceed a business sheet that can be sorted among the business sheets extracted by the robot to a sorting process, and move a business sheet that cannot be sorted to a second area of the basket.

A program according to the present disclosure causes a computer to execute processes of recognizing a business sheet placed in a first area of a basket; controlling, based on the recognition result, extraction of the business sheet from the first area of the basket by a robot; and determining whether the business sheet is sortable, wherein the robot is controlled based on the determination result to proceed a business sheet that can be sorted among the business sheets extracted by the robot to a sorting process, and move a business sheet that cannot be sorted to a second area of the basket. The program may be stored in a computer-readable non-transitory recording medium.

### Advantageous Effects of Invention

Therefore, even when there are business sheets that are difficult to process, a decrease in the processing speed of the business sheets can be suppressed.

### BRIEF DESCRIPTION OF DRAWINGS

FIG. 1 is a block diagram illustrating a configuration example of a business sheet processing system according to a first example embodiment.

FIG. 2 is a diagram illustrating an example of a basket containing a business sheet.

FIG. 3 is a flowchart illustrating an operation example of the business sheet processing system according to the first example embodiment.

FIG. 4 is a block diagram illustrating a configuration example of a business sheet sorting system according to a second example embodiment.

FIG. 5 is a diagram illustrating an arrangement example of a device.

FIG. 6 is a block diagram illustrating a configuration example of a business sheet sorting system according to a third example embodiment.

FIG. 7 is a diagram illustrating an example of data managed in a database.

FIG. 8 is a block diagram illustrating a configuration example of a business sheet sorting system according to a modified example.

FIG. 9 is a block diagram illustrating an example of a hardware configuration of a computer.

### EXAMPLE EMBODIMENT

An example embodiment of a business sheet processing system, a business sheet processing method, a program, and a recording medium that non-temporarily records the program according to the present disclosure will be described below with reference to the drawings. The business sheet includes, for example, a proxy storage paper, a slip, a gift certificate, or a receipt, but is not limited thereto, and may include other documents.

### First Example Embodiment

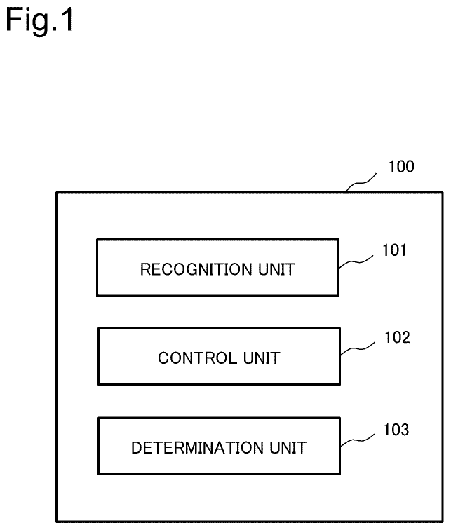

A business sheet processing system 100 according to the first example embodiment is a system that proceeds a business sheet placed in a basket to a sorting process. The business sheet is sorted into each sorting destination according to a type (content or size) of the business sheet. FIG. 1 is a block diagram illustrating a configuration example of a business sheet processing system 100 according to a first example embodiment. The business sheet processing system 100 includes a recognition unit 101, a control unit 102, and a determination unit 103.

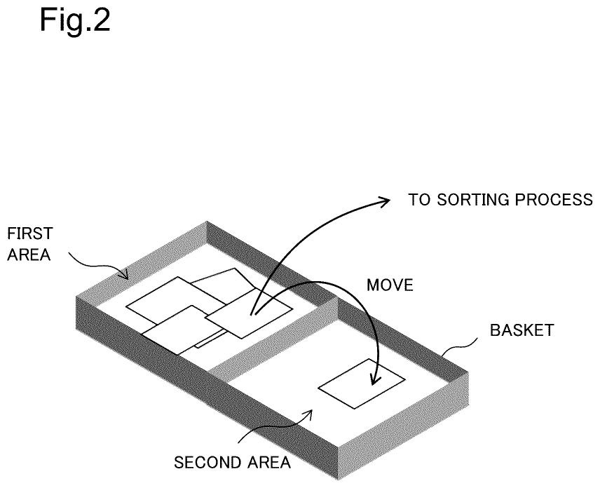

In the first example embodiment, business sheets to be sorted are placed in a first area of a basket having a first area and a second area. Here, the first area is an area in which business sheets to be sorted are placed. The second area is an area in which a business sheet determined to be un-sortable by the business sheet processing system is placed. The business sheet processing system 100 according to the first example embodiment proceeds a business sheet that can be sorted among the business sheets placed in the first area to the sorting process, and moves a business sheet that cannot be sorted to the second area. The basket on which the business sheet is placed is placed at an extracting position where the business sheet can be extracted by the robot. FIG. 2 is a diagram illustrating an example of a basket containing a business sheet. The first area and the second area may be partitioned. The basket is not limited to the business sheet illustrated in the drawing as long as the placed business sheet can be transported.

The recognition unit 101 recognizes a business sheet placed in the first area of the basket. The control unit 102 controls, based on the recognition result by the recognition unit 101, the extraction of the business sheet from the first area of the basket by the robot. The determination unit 103 determines whether the business sheets can be sorted. The control unit 102 further controls the robot to proceed a sortable business sheet that can be sorted among the business sheets extracted by the robot to sorting process and move a business sheet that cannot be sorted to the second area of the basket based on the determination result.

Each configuration will be described more specifically below.

The recognition unit 101 recognizes a business sheet placed in the first area of the basket. For example, the recognition unit 101 recognizes a business sheet based on an image obtained by photographing a business sheet placed in the first area of the basket. In this case, the recognition unit 101 acquires an image photographed by the camera. Alternatively, the recognition unit 101 may receive a result of recognition of a business sheet by a camera.

The recognition unit 101 recognizes, for example, the presence or absence of a business sheet placed in the first area. Furthermore, for example, the recognition unit 101 may recognize a side or a corner of a business sheet placed in the first area, and recognize a position and a size of the business sheet. The recognition unit 101 may recognize the position of characters or codes printed in the business sheet, and recognize the position and size of the business sheet.

In a case where a plurality of business sheets are placed in an overlapping manner, the recognition unit 101 recognizes a business sheet of an uppermost layer where there is no overlapping business sheet above. For example, the recognition unit 101 recognizes a business sheet in which a side of the business sheet or a printed character or code is not hidden by another business sheet.

The control unit 102 controls an operation in which the robot extracts a business sheet from the first area of the basket based on a recognition result by the recognition unit 101. The robot holds the business sheet and extracts the business sheet from the basket. The robot may hold the business sheet of the uppermost layer among a plurality of overlapped business sheets. The robot may hold the business sheet by adsorbing the business sheet to a flat plate or a plurality of contacts provided in the robot arm by static electricity or air suction or discharge. Alternatively, the robot may hold a business sheet by gripping the sides of the business sheet. The control unit 102 controls the position of the robot arm according to, for example, the recognized position and size of the business sheet of the uppermost layer. Furthermore, the control unit 102 controls a position where a business sheet is adsorbed by a flat plate provided in the robot arm.

In a case where the determination unit 103 described later determines that business sheets can be sorted, the control unit 102 further controls an operation in which the robot proceeds the business sheet to a sorting process. In order to proceed the business sheet to the sorting process, for example, the control unit 102 controls a robot to place the business sheet that has been extracted on a conveying device. Thereafter, the sorting process is performed on the business sheet placed on the conveying device. Alternatively, the control unit 102 may perform robot control in such a way that the robot sorts the lifted business sheets into a plurality of boxes for each type.

In addition, in a case where the determination unit 103 described later determines that business sheets can be sorted, the control unit 102 controls an operation in which the robot moves a business sheet to the second area of the basket. The control unit 102 controls the robot to place the business sheet extracted from the first area in the second area.

The determination unit 103 determines whether the business sheets can be sorted. The determination unit 103 may determine whether the business sheets can be sorted based on an image of a business sheet photographed before being extracted from a basket. Alternatively, the determination unit 103 may determine whether business sheets can be sorted based on an image obtained by photographing the business sheets that have been extracted and lifted. The business sheets that can be sorted are, for example, business sheets that can be processed by a machine that performs the sorting process. A method of determining whether business sheets are sortable can be appropriately selected.

When a plurality of business sheets are bundled using fasteners, the contents of the business sheets may not be read in the sorting process. Therefore, the business sheets that cannot be sorted include, for example, business sheets in which fasteners are retained on the business sheets. The fasteners include, for example, staples, clips, tapes, and files. A business sheet without a fastener is an example of a business sheet that can be sorted. For example, the determination unit 103 determines whether a fastener is retained in a photographed business sheet.

In addition, when a business sheet is folded, contents on the inner side may not be read. Therefore, the business sheets that cannot be sorted may include business sheets in which one or more business sheets are folded. The flattened business sheet is an example of a business sheet that can be sorted. The determination unit 103 may determine whether the business sheet is folded from the shape of the photographed business sheet.

Furthermore, when business sheets are bundled, it may be difficult to read the contents of the business sheets. A case where business sheets are bundled includes a case where business sheets are glued or are difficult to be separated from each other due to static electricity. Accordingly, the business sheets that cannot be sorted may include bundled business sheets. A business sheet that is not bundled and is separated one by one is an example of a business sheet that can be sorted. For example, in a case where a robot holds a business sheet by adsorbing, the robot adsorbs only the business sheet of the uppermost layer among the bundled business sheets, and thus the other business sheets are suspended. The determination unit 103 may recognize bundled business sheets by recognizing a suspended business sheet from an image obtained by photographing a lifted business sheet.

As described above, the business sheets placed in the first area of the baskets, which are determined to be sortable, are proceeded to the sorting process if they can be sorted, and are placed in the second area of the baskets if they cannot be sorted.

The recognition unit 101 may recognize whether the recognized business sheet can be extracted by a robot by recognizing the shape of the business sheet from the image. The business sheet that can be extracted is a business sheet that can be held by the robot from the state of being placed in the first area. A business sheet not having a prescribed shape may not be able to be extracted. For example, there is a case where a rounded business sheet is not adsorbed to a robot arm and cannot be extracted. In addition, there is a case where it is not possible to extract a business sheet on which another business sheet is overlapped. Therefore, for example, a business sheet placed under a business sheet not having a prescribed shape cannot be extracted. The control unit 102 controls the taking out by the robot of a business sheet recognized as being able to be extracted.

In a case where it is recognized that the business sheet of the uppermost layer remaining in the basket is the same business sheet as the previously recognized business sheet after the robot performs the operation of taking out the recognized business sheet, the recognition unit 101 may recognize that the remaining business sheet cannot be extracted.

A business sheet that cannot be extracted from the basket by the robot is left in the first area. In addition, a business sheet that is not recognized cannot be extracted, and therefore is left in the first area. business sheets that cannot be extracted are included in business sheets that cannot be sorted.

When there is no more business sheet in the first area of the basket and when there is no more business sheet that can be extracted from the first area, the basket is excluded from the extracting position where the business sheet is extracted by the robot. Then, the next basket is placed at the extracting position by the robot. For example, the recognition unit 101 starts recognition of a business sheet in the next basket.

There is a case where a business sheet remains in the first area or the second area of the basket excluded from the extracting position. The remaining business sheets are processed by a robot or a worker in such a way as to be in a sortable state. For example, a process of removing fasteners and a process of smoothing wrinkles are performed in such a way that business sheets can be sorted. The business sheet processed to the sortable state is placed again in the first area of the basket. Then, the basket is placed at the extracting position again.

Objects other than the business sheet to be sorted, such as dust remaining in the excluded basket, are removed from the basket. In addition, when it is difficult to process the business sheets remaining in the excluded basket in such a way as to be sortable, the business sheets may be removed without being returned to the basket.

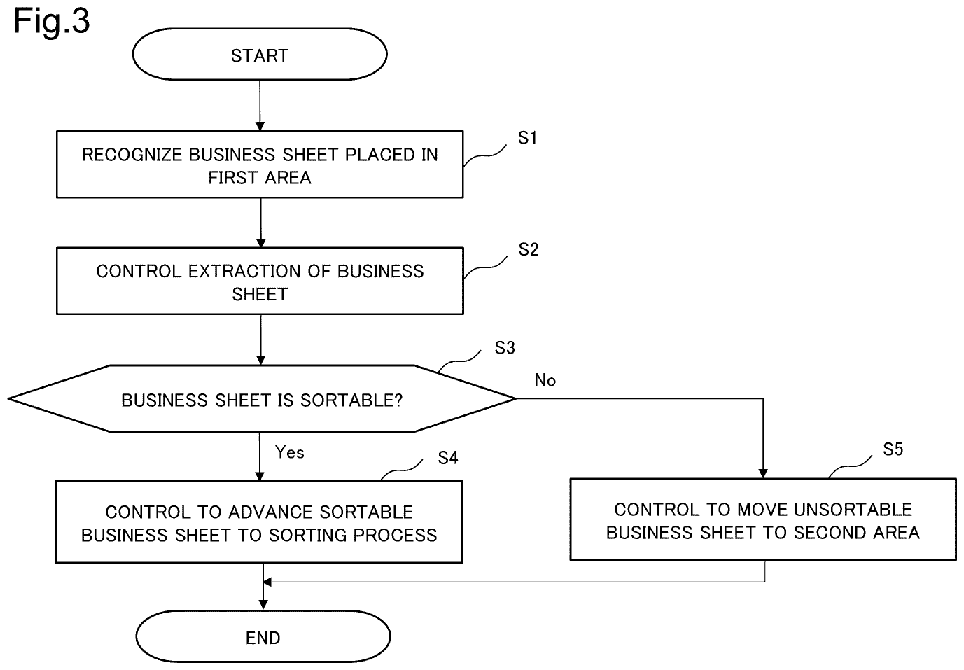

FIG. 3 is a flowchart illustrating an operation example of a business sheet processing system 100 according to the first example embodiment. The business sheet processing system 100 may start the operation of the flowchart in response to the basket being placed at a position where the business sheet can be extracted by the robot.

First, the recognition unit 101 recognizes a business sheet placed in the first area of the basket (step S1). The recognition unit 101 transmits the recognition result to the control unit 102. The control unit 102 controls, based on the recognition result, the extraction of the business sheet from the first area of the basket by the robot (step S2).

Next, the determination unit 103 determines whether the business sheet that has been extracted can be sorted (step S3). The determination unit 103 transmits the determination result to the control unit 102. Step S3 may be executed before step S2. That is, the determination as to whether the business sheets can be sorted may be performed before the business sheets are extracted, or may be performed after the business sheets are extracted.

When the business sheets can be sorted (step S3: Yes), the control unit 102 controls the robot to proceed the business sheets that can be sorted extracted by the robot to the sorting process (step S4). When the business sheets cannot be sorted (step S3: No), the control unit 102 controls the robot in such a way as to move the business sheets that cannot be sorted extracted by the robot to the second area of the basket (step S5).

According to the first example embodiment, the business sheets placed in the first area of the basket are extracted, the business sheets that can be sorted are proceeded to the sorting process, and the business sheets that cannot be sorted are moved to the second area of the basket. Therefore, for example, it is possible to further extract a business sheet placed under the business sheet extracted. In addition, for example, in a case where there is no business sheet that can be extracted from the first area, it is possible to start the taking out of a business sheet placed in the first area of the next basket. Therefore, even when there are business sheets that cannot be sorted, it is possible to suppress a decrease in the processing speed of the business sheets.

### Second Example Embodiment

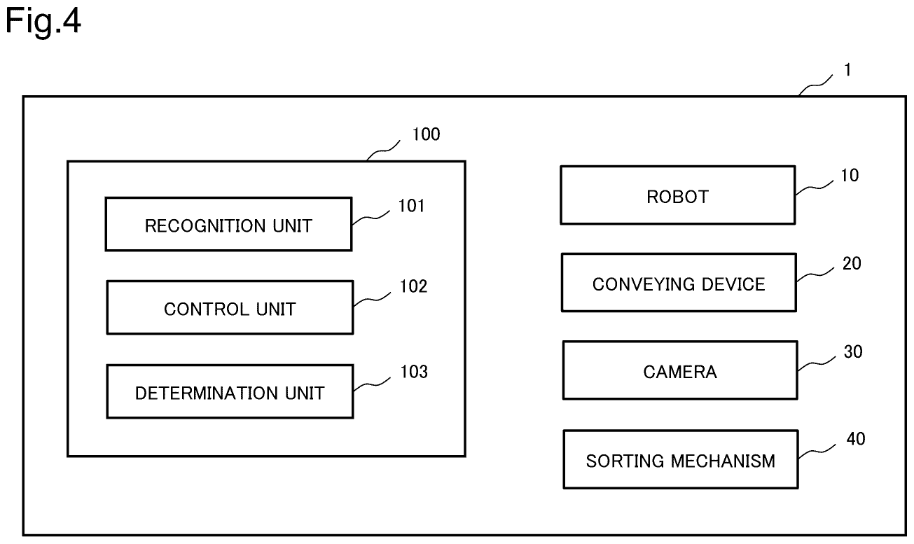

Next, as a second example embodiment, another example of the business sheet processing system 100 will be described. In the second example embodiment, the business sheet processing system 100 is included in a business sheet sorting system 1. FIG. 4 is a block diagram illustrating a configuration example of the business sheet sorting system 1 according to the second example embodiment. A configuration of the business sheet processing system 100 according to the second example embodiment is similar to the configuration according to the first example embodiment, and thus description thereof will be omitted. That is, the business sheet processing system 100 according to the present example embodiment performs a process of advancing business sheets that can be sorted among business sheets placed in the first area of the basket to the sorting process, and moving business sheets that cannot be sorted to the second area of the basket.

The business sheet sorting system 1 according to the second example embodiment includes a robot 10, a conveying device 20, a camera 30, and a sorting mechanism 40.

The robot 10 operates in accordance with control by the control unit 102. For example, the robot 10 lifts a business sheet placed in the first area of the basket and proceeds the business sheet to the sorting process. For example, the robot 10 places a business sheet on the conveying device 20 in order to proceed the business sheet to the sorting process. In addition, in a case where it is determined that business sheets cannot be sorted, the robot 10 stops the operation of advancing the business sheet to the sorting process. Then, the robot 10 moves the business sheet that cannot be sorted extracted from the first area of the basket to the second area.

The conveying device 20 conveys the business sheet to the sorting mechanism 40. The conveying device 20 is, for example, a roller conveyor that conveys a business sheet by rotating each of the rollers arranged in parallel. The conveying device 20 may include a conveyor belt.

The camera 30 photographs a business sheet placed in the basket. For example, the camera 30 photographs a business sheet placed in the first area of the basket.

The sorting mechanism 40 sorts a business sheet into a plurality of sorting destinations according to types by an existing sorting technique. Types of business sheets are recognized by a camera, a scanner, or other sensors. Types of business sheets to be sorted to each sorting destination are set in advance by an administrator or the like.

The sorting mechanism 40 sorts the business sheets into sorting destinations according to the type (content or size) of the business sheets. For example, the sorting mechanism 40 may sort business sheets according to the size of paper. In addition, the business sheets may be sorted according to contents such as proxy storage paper, a slip, a gift certificate, a receipt, and other documents. The business sheets may be sorted by subsequent processing steps such as whether the business sheets are data input targets, whether the business sheets are storage targets, and whether the business sheets are return targets to a store. The business sheets may be further sorted by business sheet name. In a case where the business sheet is a gift certificate, the gift certificates may be further sorted according to whether they are cashing targets. A plurality of different types of business sheets may be sorted to the same sorting destination.

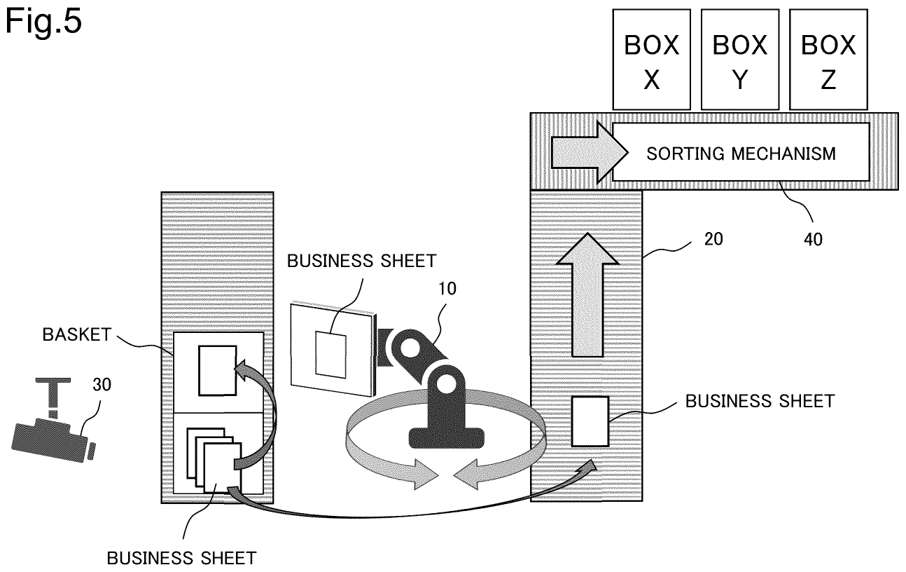

FIG. 5 is a diagram illustrating an arrangement example of the robot 10, the conveying device 20, the camera 30, and the sorting mechanism 40. In FIG. 5, business sheets are stacked in a first area of a basket.

When the basket in which the business sheet is placed is arranged at a predetermined position for extracting the business sheet, the camera 30 photographs the business sheet in the basket. The robot 10 extracts a business sheet that can be sorted from the basket and places the business sheet on the conveying device 20. Then, the robot 10 moves the business sheet that cannot be sorted from the first area to the second area of the basket. The conveying device 20 conveys the placed business sheet to the sorting mechanism 40. The sorting mechanism 40 sorts the business sheet to each sorting destinations (Box X, Box Y, and Box Z) for each type of business sheet.

According to the second example embodiment, business sheets extracted from a basket are sorted. According to the second example embodiment, the business sheets placed in the first area of the basket are extracted, the business sheets that can be sorted are proceeded to the sorting process, and the business sheets that cannot be sorted are moved to the second area of the basket. Therefore, even when there are business sheets that cannot be sorted, it is possible to suppress a decrease in the speed of the sorting process of the business sheets.

### Third Example Embodiment

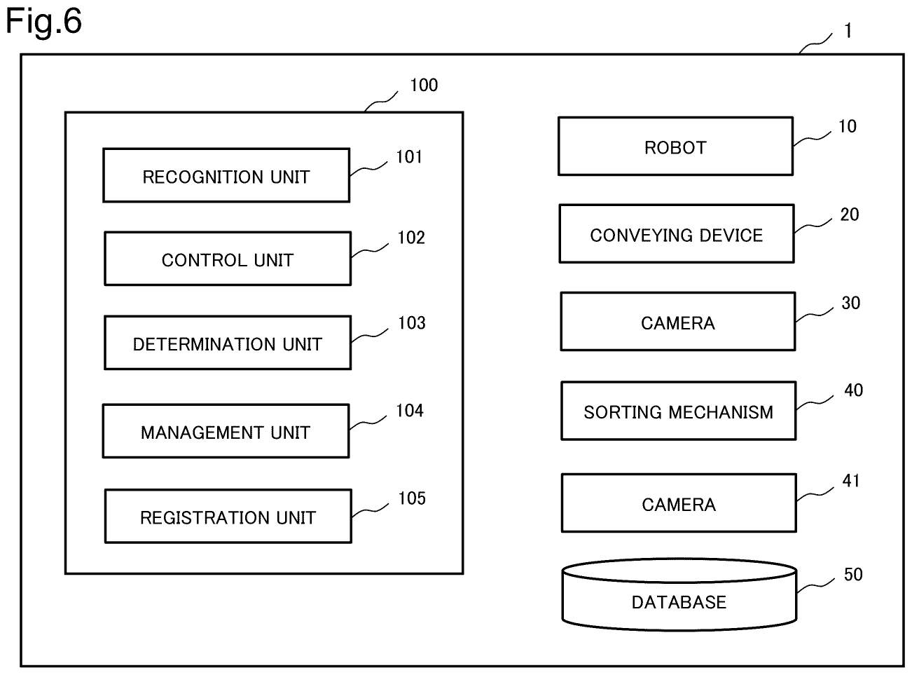

Next, as a third example embodiment, another example of the business sheet sorting system 1 will be described. FIG. 6 is a block diagram illustrating a configuration example of the business sheet sorting system 1 according to the third example embodiment. The business sheet sorting system 1 according to the third example embodiment is different from the business sheet sorting system 1 according to the second example embodiment in including a camera 41 and a database 50. The business sheet processing system 100 according to the third example embodiment includes a recognition unit 101, a control unit 102, a determination unit 103, a management unit 104, and a registration unit 105. Regarding the configuration according to the third example embodiment, description on the configuration similar to that of the second example embodiment will be omitted. The business sheet sorting system 1 according to the third example embodiment is, for example, a system that sorts business sheets collected from a convenience store, but business sheets to be sorted may be other business sheets and are not particularly limited.

The business sheets collected from convenience stores are collected and transported for each store. The transported business sheets are placed in baskets for sorting process. In the third example embodiment, the business sheet may be managed in association with information for identifying a store. In this case, for example, a store identifier for identifying a store may be attached to a bag for transporting the business sheets collected for each store. Alternatively, a paper printed with a store identifier may be put in a bag for transporting business sheets. The store identifier is represented by a character, a barcode, or a two-dimensional code.

In the third example embodiment, a basket identifier for identifying a basket may be attached to each basket. The basket identifier is represented by a character, a barcode, a two-dimensional code, or any pattern. The business sheets are placed in different baskets for each store.

The registration unit 105 registers association between a store identifier of a store from which a business sheet is collected and a basket identifier attached to a basket in which the business sheet collected from the store is placed. That is, the business sheet placed in the basket is handled as a business sheet collected by the registration unit 105 at the store represented by the store identifier associated with the basket identifier.

In order to register association of store identifiers, a store identifier printed on a bag for transporting business sheets or on a paper put in the bag is read by an arbitrary scanner. The registration unit 105 acquires the store identifier read by the scanner. In addition, the registration unit 105 may acquire the store identifier input by the worker using an arbitrary input device such as a keyboard.

Furthermore, the registration unit 105 acquires the basket identifier of the basket in which the business sheet collected from the store corresponding to the store identifier is placed. The registration unit 105 may acquire the basket identifier from the same scanner as the scanner that has acquired the store identifier. In addition, the registration unit 105 may acquire the basket identifier based on the image of the basket photographed by the camera 30.

The registration unit 105 registers the association between the acquired basket identifier and the store identifier. The registration unit 105 may register the continuously acquired basket identifier and store identifier as corresponding identifiers.

When recognizing the business sheet placed in the first area of the basket, the recognition unit 101 recognizes the basket identifier attached to the basket from the image. The recognition unit 101 may attach a business sheet identifier to the recognized business sheet. The recognition unit 101 transmits the business sheet identifier and the recognized basket identifier to the management unit 104 in association with each other. The recognition unit 101 transmits the business sheet placed in the same basket in association with the same basket identifier. When the basket is exchanged, the recognition unit 101 again recognizes the basket identifier attached to the basket.

The management unit 104 manages the store identifier associated with the basket identifier of the basket from which the business sheet has been extracted and the business sheet in association with each other.

The management unit 104 manages, for example, a store identifier and information described in a business sheet in association with each other. In order to manage the information, first, the management unit 104 receives the basket identifier of the basket from which the business sheet has been extracted from the recognition unit 101. Then, the management unit 104 acquires the store identifier registered in association with the basket identifier. Furthermore, the management unit 104 acquires information described in a business sheet based on an image of the business sheet photographed by the camera 41.

The camera 41 photographs an image from which information described in a business sheet can be read. The camera 41 may be a scanner. The camera 41 may photograph both front and back sides of a business sheet.

For example, the camera 41 photographs a business sheet determined to be sortable. The camera 41 may photograph a business sheet placed on the conveying device 20. In addition, the camera 41 may photograph a business sheet before, during, or after sorting by the sorting mechanism 40.

The management unit 104 manages that the business sheet recognized by the recognition unit 101 and the business sheet photographed by the camera 41 are the same. As a result, the management unit 104 can manage from which basket the business sheet has been extracted. In some cases, a business sheet is photographed by the camera 41 in the order in which the business sheet is recognized by the recognition unit 101 and extracted. In this case, for example, the management unit 104 associates the business sheet identifiers sequentially received from the recognition unit 101 with the photographed business sheets in the order of photographing by the camera 41.

The management unit 104, for example, extracts information described in a business sheet from an image photographed by the camera 41 using a character recognition technique. Alternatively, the management unit 104 may acquire, from the camera 41, the result of the camera 41 extracting information described in the business sheet from an image. The management unit 104 may acquire an image obtained by photographing a paper surface of a business sheet as information described in the business sheet.

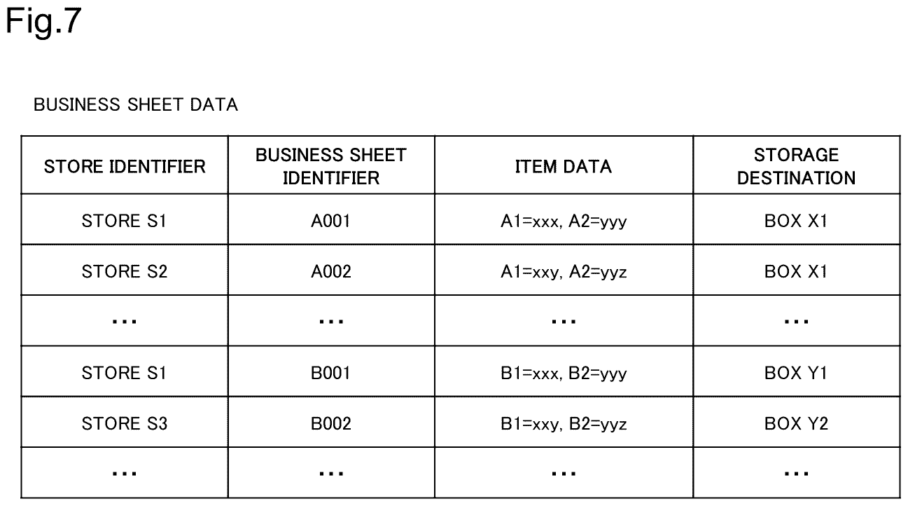

For example, the management unit 104 manages information by storing a store identifier and information described in a business sheet in the database 50 in association with each other. FIG. 7 is a diagram illustrating an example of business sheet data stored in the database 50. The business sheet data includes a store identifier, a business sheet identifier, item data, and a storage destination.

The item data is data indicating matters described for each item included in the business sheet. The management unit 104 may acquire data for each item included in a business sheet using an existing recognition technique. For example, the management unit 104 acquires that data xxx is described in the item A1 and data yyy is described in the item A2 in the business sheet of the business sheet identifier A001, and manages information. The database 50 may store an image obtained by photographing a paper surface of a business sheet instead of data for each item.

The storage destination is, for example, an identifier of a box arranged at the sorting destination. In addition, the storage destination may be an identifier for identifying a storage place where a business sheet is stored. Furthermore, the storage destination may be a combination of an identifier for identifying a storage place where a business sheet is stored and an identifier of a storage means.

Furthermore, the management unit 104 may instruct a printer to print the store identifier associated with the basket identifier of the basket in which the business sheet is placed on the business sheet. In addition, the management unit 104 may instruct a printer to print a business sheet identifier on a business sheet. When the business sheet identifier is printed, the store identifier of the store where the business sheet is collected can be grasped by referring to the database 50. For example, the printer prints an identifier on a business sheet before being sorted by the sorting mechanism 40.

The registration unit 105 maintains the association between the basket identifier and the store identifier while the business sheet remains in at least one of the first area and the second area of the basket. For example, the registration unit 105 maintains the association between the basket identifier and the store identifier even while the process of removing the fasteners and the process of smoothing wrinkles are performed in such a way that the business sheets placed in the second area of the basket can be sorted. In this case, the business sheets processed in such a way as to be sortable are placed in the first area of the same basket. In addition, in a case where it is recognized that there is no business sheet in the first area and the second area of the basket, the registration unit 105 may cancel the association between the basket identifier and the store identifier. Means for recognizing that there is no business sheet in the first area and the second area of the basket and that the basket is empty is not particularly limited. For example, when the worker confirms that the basket is empty, the registration unit 105 may cancel the association according to the operation of the worker.

Furthermore, in order to perform the process of canceling the association, the camera 30 may further photograph a business sheet placed in the second area of the basket. The recognition unit 101 may recognize a business sheet placed in the second area of the basket from the photographed image. The registration unit 105 acquires, from the recognition unit 101, a recognition result as to whether there is a business sheet in the first area and the second area.

A business sheet collected from the next store is placed in a basket in which no business sheet is placed. Then, the registration unit 105 registers the association between the basket identifier and the store identifier of the next store.

In the third example embodiment, the management unit 104, the registration unit 105, the camera 41, and the database 50 may be provided as necessary.

In the third example embodiment, an example in which the camera 30 and the camera 41 are achieved by separate cameras is illustrated. However, the camera 30 and the camera 41 may be achieved by a single camera according to, for example, conditions such as the type of business sheet. In this case, information described in a business sheet is read based on an image obtained by photographing the business sheet placed in the basket.

In the third example embodiment, the determination unit 103 may determine a reason why business sheets cannot be sorted. Determination on the reason why sorting is impossible may be made using a known image recognition technique. Then, the reason why the business sheets cannot be sorted may be output to the display. For example, the recognition unit 101 transmits the recognized basket identifier to the determination unit 103. Then, the determination unit 103 determines the reason why the business sheets placed in the baskets cannot be sorted for each basket identifier. Thereafter, in response to the fact that the basket identifier is read by the scanner, the reason why the business sheets remaining in the basket cannot be sorted is output to the display. The worker can grasp what kind of process to perform to make the business sheets sortable by displaying on the display the reason why the business sheets cannot be sorted.

In the third example embodiment, when there are business sheets that cannot be sorted, the business sheets are returned to the second area of the same basket. Then, for example, the business sheets are processed in such a way as to be sortable by manual work or the like. The business sheet that can be processed is returned to the first area of the basket again, and is passed to be extracted by the robot. Therefore, it is possible to proceed the basket to the process of making the business sheets sortable while maintaining association between the store where business sheets are collected and the business sheets. Therefore, according to the third example embodiment, a decrease in the processing speed of the business sheet can be suppressed while maintaining association between the store and the business sheet.

### Modified Example

The above example embodiments can be variously modified. Here, modified examples will be described.

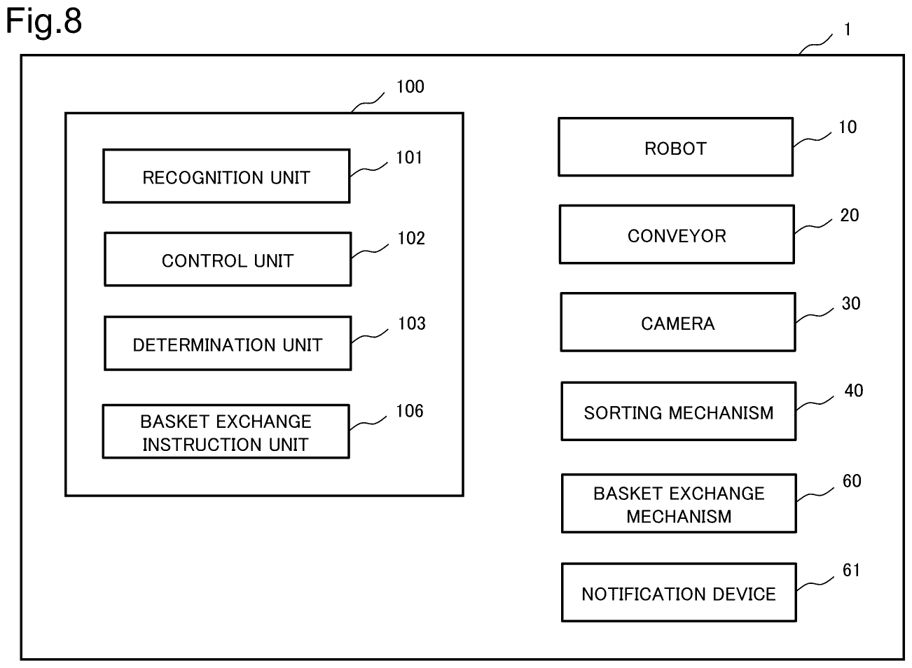

FIG. 8 is a block diagram illustrating a configuration example of a business sheet sorting system 1 according to a modified example. The business sheet sorting system 1 according to a modified example is different from the business sheet sorting system 1 according to the second example embodiment in including a basket exchange mechanism 60 and a notification device 61. The basket exchange mechanism 60 and the notification device 61 may be provided as necessary. In addition, a business sheet processing system 100 according to the modified example is different from the first example embodiment and the second example embodiment in including a basket exchange instruction unit 106.

When there is no business sheet that can be taken out from the first area, the basket exchange instruction unit 106 instructs to exclude the basket from the extracting position by the robot. The basket exchange instruction unit 106 receives from the recognition unit 101 a notice that there is no business sheet that can be extracted. Then, the basket exchange instruction unit 106 causes, for example, the basket exchange mechanism 60 to exclude the basket. Alternatively, the basket exchange instruction unit 106 causes the notification device 61 to notify that the basket needs to be exchanged.

The basket exchange mechanism 60 excludes the basket from which no business sheet can be extracted. The basket exchange mechanism 60 is, for example, a roller conveyor. Alternatively, the basket exchange mechanism 60 may be a robot that transports a basket. The basket exchange mechanism 60 may transport the basket to a position where the process of making the business sheets that cannot be sorted to be sortable is performed.

The notification device 61 notifies that the basket needs to be exchanged. The notification device 61 is, for example, a display, a lamp, or a speaker. In response to the notification, the worker excludes the basket and places the next basket at the extracting position.

The robot 10 can promptly start to extract the business sheet in the next basket by having the basket exchange instruction unit 106 exclude baskets that have no business sheets that can be extracted. Therefore, a decrease in the processing speed can be suppressed.

### [Hardware Configuration]

In each of the example embodiments described above, each component of the business sheet processing system 100 indicates a block of a functional unit. Some or all of the components of the business sheet processing system 100 may be achieved by an arbitrary combination of a computer 500 and a program.

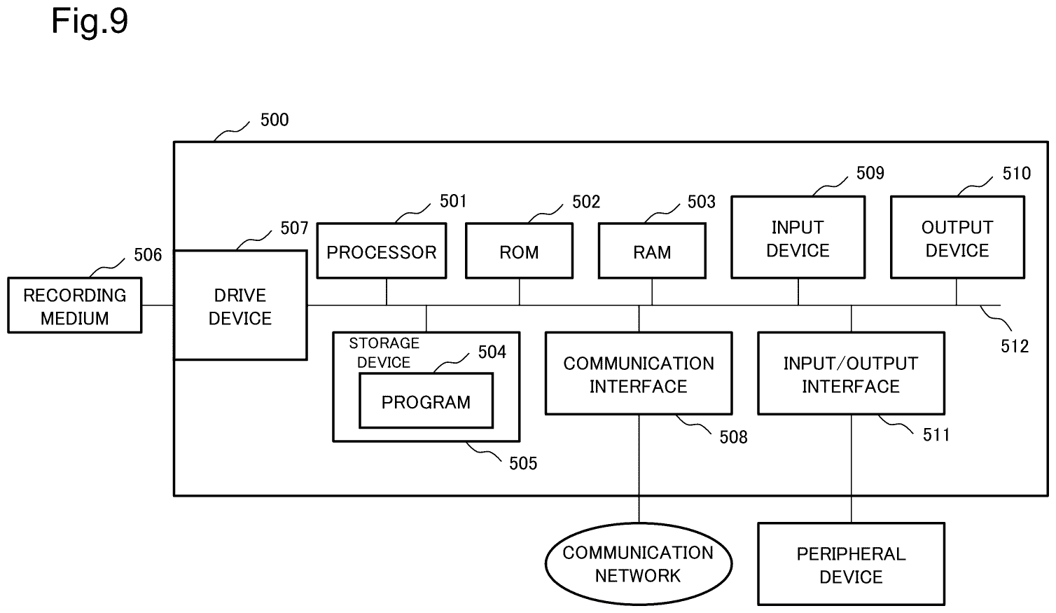

FIG. 9 is a block diagram illustrating an example of a hardware configuration of the computer 500. Referring to FIG. 9, the computer 500 includes, for example, a processor 501, a read only memory (ROM) 502, a random access memory (RAM) 503, a program 504, a storage device 505, a drive device 507, a communication interface 508, an input device 509, an input/output interface 511, and a bus 512.

The processor 501 controls the entire computer 500. Examples of the processor 501 include, for example, a central processing unit (CPU) and the like. The number of processors 501 is not particularly limited, and the number of processors 501 is one or more.

The program 504 includes a command (instruction) for achieving each function of the business sheet processing system 100. The program 504 is stored in advance in the ROM 502, the RAM 503, and the storage device 505. The processor 501 achieves each function of the business sheet processing system 100 by executing commands included in the program 504. The RAM 503 may store data to be processed by each function of the business sheet processing system 100.

The drive device 507 reads and writes the recording medium 506. The communication interface 508 provides an interface with a communication network. The input device 509 is, for example, a mouse, a keyboard, or the like, and receives an input of information from a manager or the like. The output device 510 is, for example, a display, and outputs (displays) information to a manager or the like. The input/output interface 511 provides an interface with a peripheral device. The bus 512 connects the components of the hardware. The program 504 may be provided to the processor 501 via a communication network, or may be stored in the recording medium 506 in advance, read by the drive device 507, and provided to the processor 501.

The hardware configuration illustrated in FIG. 9 is an example, and other components may be added or some components may not be included.

There are various modified examples for the method for achieving the business sheet processing system 100. For example, the business sheet processing system 100 may be achieved by an arbitrary combination of a computer and a program different for each component. Furthermore, a plurality of components included in the business sheet processing system 100 may be achieved by an arbitrary combination of one computer and a program.

Although the present disclosure has been described with reference to the example embodiments, the present disclosure is not limited to these example embodiments. Various changes that can be understood by those skilled in the art can be made to the configuration and details of the present disclosure within the scope of the present disclosure. The configurations in the example embodiments can be combined with each other without departing from the scope of the present disclosure.

Some or all of the above example embodiments can be described as the following supplementary notes, but are not limited to the following.

### [Supplementary Note 1]

A business sheet processing system including:
a recognition means for recognizing a business sheet placed in a first area of a basket;
a control means for controlling, based on the recognition result, extraction of the business sheet from the first area of the basket by a robot; and
a determination means for determining whether the business sheet is sortable, wherein
the control means controls the robot based on the determination result to proceed a business sheet that can be sorted among the business sheets extracted by the robot to a sorting process, and move a business sheet that cannot be sorted to a second area of the basket.

### [Supplementary Note 2]

The business sheet processing system according to supplementary note 1, further including:
a management means for managing a store identifier associated with a basket identifier of the basket from which the business sheet has been extracted and the business sheet in association with each other.

### [Supplementary Note 3]

The business sheet processing system according to supplementary note 2, further including:
a registration means for registering an association between a store identifier of a store from which the business sheet has been collected and a basket identifier attached to the basket in which the business sheet collected from the store has been placed.

### [Supplementary Note 4]

The business sheet processing system according to supplementary note 3, wherein
the registration means cancels association between the basket identifier and the store identifier when recognized that there is no business sheet in the first area and the second area of the basket.

### [Supplementary Note 5]

The business sheet processing system according to any one of supplementary notes 1 to 4, further including:
a basket exchange instruction means for instructing to exclude the basket from a position where the robot extracts the business sheet in a case where there is no more business sheet extractable from the first area.

### [Supplementary Note 6]

The business sheet processing system according to any one of supplementary notes 1 to 5, wherein
the business sheets that cannot be sorted are business sheets with fasteners or unreadable business sheets.

### [Supplementary Note 7]

The business sheet processing system according to any one of supplementary notes 1 to 6, wherein
the determination means determines whether the business sheet is sortable based on an image obtained by photographing the inside of the basket.

### [Supplementary Note 8]

The business sheet processing system according to any one of supplementary notes 1 to 7, wherein
the determination means determines whether the business sheet is sortable based on an image obtained by photographing a business sheet lifted from the basket.

### [Supplementary Note 9]

A business sheet processing method including:
recognizing a business sheet placed in a first area of a basket;
controlling, based on the recognition result, extraction of the business sheet from the first area of the basket by a robot; and
determining whether the business sheet is sortable, wherein
the robot is controlled based on the determination result to proceed a business sheet that can be sorted among the business sheets extracted by the robot to a sorting process, and move a business sheet that cannot be sorted to a second area of the basket.
   [Supplementary note 10]

A recording medium that temporarily records a program for causing a computer to execute processes of:
recognizing a business sheet placed in a first area of a basket;
controlling, based on the recognition result, extraction of the business sheet from the first area of the basket by a robot; and
determining whether the business sheet is sortable, wherein
the robot is controlled based on the determination result to proceed a business sheet that can be sorted among the business sheets extracted by the robot to a sorting process, and move a business sheet that cannot be sorted to a second area of the basket.

### REFERENCE SIGNS LIST

1 business sheet sorting system
100 business sheet processing system
101 recognition unit
102 control unit
103 determination unit
104 management unit
105 registration unit
106 basket exchange instruction unit
10 robot
20 conveying device
30 camera
40 sorting mechanism
50 database
60 basket exchange mechanism
61 notification device

What is claimed is:

1. A business sheet processing system comprising:
at least one memory configured to store instructions; and
at least one processor configured to execute the instructions to:
recognize a business sheet placed in a first area of a basket;
control, based on the recognition result, extraction of the business sheet from the first area of the basket by a robot;
determine whether the business sheet is sortable;
control the robot to proceed a business sheet extracted by the robot and determined to be sortable to a sorting process; and
control the robot to move a business sheet extracted by the robot and determined to be unsortable to a second area of the basket.

2. The business sheet processing system according to claim 1, wherein the at least one processor is further configured to execute the instructions to:
store information of a store identifier associated with a basket identifier of the basket from which the business sheet has been extracted and the business sheet in association with each other.

3. The business sheet processing system according to claim 2, wherein the at least one processor is further configured to execute the instructions to:
register an association between a store identifier of a store from which the business sheet has been collected and a basket identifier attached to the basket in which the business sheet collected from the store has been placed.

4. The business sheet processing system according to claim 3, wherein the at least one processor is further configured to execute the instructions to:
cancel association between the basket identifier and the store identifier when recognized that there is no business sheet in the first area and the second area of the basket.

5. The business sheet processing system according to claim 1, wherein the at least one processor is further configured to execute the instructions to:
give an instruction to remove the basket from a position where the robot extracts the business sheet in a case where there is no more business sheet extractable from the first area.

6. The business sheet processing system according to claim 1, wherein
the business sheets that are unsortable are business sheets with fasteners or unreadable business sheets.

7. The business sheet processing system according to claim 1, wherein the at least one processor is further configured to execute the instructions to:
determine whether the business sheet is sortable based on an image obtained by photographing an inside of the basket.

8. The business sheet processing system according to claim 1, wherein the at least one processor is further configured to execute the instructions to:
determine whether the business sheet is sortable based on an image obtained by photographing a business sheet lifted from the basket.

9. A business sheet processing method comprising:
recognizing a business sheet placed in a first area of a basket;
controlling, based on the recognition result, extraction of the business sheet from the first area of the basket by a robot; and
determining whether the business sheet is sortable, wherein
the robot is controlled based on the determination result to proceed a business sheet that can be sorted among the business sheets extracted by the robot to a sorting process, and move a business sheet that cannot be sorted to a second area of the basket.

10. A non-transitory computer-readable recording medium that records a program for causing a computer to execute processes of:
recognizing a business sheet placed in a first area of a basket;
controlling, based on the recognition result, extraction of the business sheet from the first area of the basket by a robot; and
determining whether the business sheet is sortable, wherein
the robot is controlled based on the determination result to proceed a business sheet that can be sorted among the business sheets extracted by the robot to a sorting process, and move a business sheet that cannot be sorted to a second area of the basket.
